(19) United States
(12) Patent Application Publication
(10) Pub. No.: US 2013/0343050 A1
(43) Pub. Date: Dec. 26, 2013

(54) INNOVATIVE LED TUBE LIGHT FIXTURE

(71) Applicant: Caishuang Hu, Xiaolan Zhongshan (CN)

(72) Inventor: Caishuang Hu, Xiaolan Zhongshan (CN)

(21) Appl. No.: 13/641,435

(22) PCT Filed: Dec. 6, 2011
(86) PCT No.: PCT/CN2011/002036

§ 371 Date: Oct. 15, 2012

(30) Foreign Application Priority Data
Mar. 11, 2011 (CN) 201120066365.6

(51) Int. Cl. F21V 23/06

(52) U.S. Cl. CPC F21V 23/06
USPC 362/217.16; 362/217.14

(57) ABSTRACT

This utility model discloses a new type of LED light fixture, which includes an aluminium tube; an LED luminaire module, attached to said aluminium tube; a driving circuit module, electrically connected with said LED luminaire module; an electric joint, comprising two conductive leads and a ground lead, the two conductive leads are electrically connected with said driving circuit module and the ground lead is connected to said aluminium tube; power source, supplying electric energy to said electric joint. This fixture reduces metal materials and makes for longer life span, safer use and more convenient installation. The fixture can directly provide electricity to LED light and is very easy for installation.

### TECHNICAL FIELD

This utility model relates to lighting field, in particular relates to a new LED light fixture.

### BACKGROUND ART

Currently, as people's environmental awareness has been continuously enhanced, LED tubes, with their remarkable effects in power saving and energy conservation, have gradually replaced traditional fluorescent tubes. What is common at present is to use an LED tube with the original fluorescent light fixture, where the ballasts on the original fluorescent tube and fixture are either removed or short-circuited and the original starter is removed as well. Although this method may also be energy efficient, the installation is relatively complicated as it can only be done by professionals. For people without professional training, there exist potential safety risks to install the LED tube with the fluorescent light fixture. In addition, as the fluorescent light fixture contains metal materials and the LED tube is also equipped with metal materials which is effective in heat dissipation, the combination of the two may lead to a great waste of metal materials, which violates the policy to save energy, protect the environment, reduce carbon emission and greenhouse gas emission proposed by people around the world.

### DISCLOSURE OF THE UTILITY MODEL

This utility model discloses a new type of LED light fixture, which can effectively resolve the problems that exist in the background art.

In order to solve the problems existing in the background art, this utility model adopts the following technical solution: it includes a lampshade 1, an LED luminaire module 2, an aluminium tube 3, a female end cover 4, a screw 5, a female plug terminal 6, a protective cover 7, a connector 8, a nut 9, a screw 10, an installation buckle 11, a spring 12, a driving circuit module 13, a heat-shrinkable tube 14, a male plug end cover 15, a male plug terminal 16, a protective cover 17, a power supply plug wire 18, a male socket 19 and a protective cover 20. Lampshade 1 covers the surface of aliminium tube 3 and LED luminaire module 2 is installed within the installation groove of aluminium tube 3. Female plug terminal 6 is clasped on female end cover 4, and connected to driving circuit module 13 through two leads. Another ground lead terminal of female plug terminal 6 is fixed with screw 10 via nut 9 on aluminium tube 3. Female end cover 4 is fixed via screw 5 at one end of the aluminium tube 3. Male plug terminal 16 is clasped on male socket end cover 15, and connected to driving circuit module 13 through two leads. The ground lead of male plug terminal 16 is fixed with screw 10 via nut 9 on aluminium tube 3. Male plug end cover 15 is fixed via screw 5 at the other end of the aluminium tube 3. Male socket end cover 15 is set with corresponding power supply plug wire 18 which supplies power through male plug terminal 16 to driving circuit module 13. After converted, driving circuit module 13 supplies power through a lead to LED luminaire module 2 to make it work reliably and stably. There is another optional power supply mode. At the back of aluminium tube 3 is set with male socket 19 into which male plug terminal 16 is plugged. Male plug terminal 16 connects with driving circuit module 13 through leads. Another ground lead terminal of male plug terminal 16 is fixed with screw 10 via nut 9 on aluminium tube 3. When the power source supplies power through male socket 19, male end cover 15 is covered by protective cover 17 to prevent electrical shock. Said connector 8 enables effective extension between LED light fixtures. When the extension is not needed, protective cover 7 covers female end cover 4 to prevent it from touching female plug terminal 6. Heat-shrinkable tube 14 is set on driving circuit module 13. Installation buckle 11 is buckled on aluminium tube 3. Torsional spring 12 is buckled on installation buckle 11. When installed, torsional spring 12 stretches to make the overall LED light fixture clasped on the ceiling. As another optional installation method, aluminium tube 3 is buckled on installation buckle 22 which is further fixed via screw and expandable pole 23 on the wall.

In other words, in order to solve the problems existing in the background art, this utility model adopts the following technical solution: it includes a lampshade 1, an LED luminaire module 2, an aluminium tube 3, a female end cover 4, a screw 5, a female plug terminal 6, a protective cover 7, a connector 8, a nut 9, a screw 10, an installation buckle 11, a spring 12, a driving circuit module 13, a heat-shrinkable tube 14, a male plug end cover 15, a male plug terminal 16, a protective cover 17, a power supply plug wire 18, a male socket 19 and a protective cover 20. Lampshade 1 covers the surface of aluminum tube 3 and LED luminaire module 2 is installed within the installation groove of aluminium tube 3. Female plug terminal 6 is connected with three leads and clasped on female end cover 4, female plug terminal 6 is connected to driving circuit module 13 through two leads. Another lead connected to female plug terminal 6 is a ground lead, which is fixed with screw 10 via nut 9 on aluminium tube 3. Aluminium tube 3 is connected with the ground lead. Female end cover 4 is fixed via screw 5 at one end of the aluminium tube 3. Male plug terminal 16 is connected with three leads and clasped on male socket end cover 15, male plug terminal 16 is connected to driving circuit module 13 through two leads. Another lead connected with male plug terminal 16 is a ground lead, which is fixed with screw 10 via nut 9 on aluminium tube 3. Male socket end cover 15 is fixed via screw 5 at the other end of the aluminium tube 3. Male socket end cover 15 is set with corresponding power supply plug wire 18 which supplies power through male plug terminal 16 to driving circuit module 13. Driving circuit module 13 converts and supplies power through a lead to LED luminaire module 2 to make it work reliably and stably. There is another optional power supply mode. At the back of aluminium tube 3 is set with male socket 19 into which male plug terminal 16 is plugged. Male plug terminal 16 connects with driving circuit module 13 through two leads. Another ground lead terminal of male plug terminal 16 is fixed with screw 10 via nut 9 on aluminium tube 3. When the power source supplies power through other parts to the LED light, male end cover 19 is covered by protective cover 20 to prevent electrical shock. When the power source supplies power through male socket 19, male end cover 15 is covered by protective cover 17 to prevent electrical shock. Heat-shrinkable tube 14 is set on driving circuit module 13. Said connector 8 enables effective extension between LED light fixtures. When the extension is not needed, protective cover 7 covers female end cover 4 to prevent it from touching female plug terminal 6. Installation buckle 11 is buckled on aluminium tube 3. Torsional spring 12 is buckled on installation buckle 11. When installed, torsional spring 12 stretches to make the overall LED light fixture clasped on the ceiling. As another optional installation method, aluminium tube 3 is buckled on installation buckle 22 which is further fixed via screw and expandable pole 23 on the wall.

In particular, this utility model provides a new type of LED light fixture, which includes:

An aluminium tube;

An LED luminaire module, attached to said aluminium tube;

A driving circuit module, electrically connected with said LED luminaire module;

An electric joint, comprising two conductive leads and a ground lead. The two conductive leads are electrically connected with said driving circuit module and the ground lead is connected to said aluminium tube;

Power source, supplying electric energy to said electric joint.

Preferably, there are two said electric joints in the said LED light fixture, one being a male electric joint and the other a female electric joint, installed at the two ends of said aluminium tube respectively.

Preferably, in the said LED light fixture, said electric joints are installed at the rear of said aluminium tube.

Preferably, in the said LED light fixture, said electric joint includes an end cover and a plug terminal. Said end cover is fixed at one end of the aluminium tube and said plug terminal extends outwardly from within said end cover. The extending end of said plug terminal is electrically connected to the power source while the non-extending end is connected to the driving circuit module.

Preferably, in the said LED light fixture, said electric joint also includes a protective cover which covers said end cover to protect the extending end of said plug terminal within the space formed between said protective cover and the end cover.

Preferably, said LED light fixture also includes a connector. One end of said connector is a male connector and the other end is a female connector. Said connector is connected with either of said electric joints.

Preferably, said LED light fixture also includes installation components which include:

A bracket, supporting the bottom of said aluminium tube;

An opening and closing component, connected with said bracket. Said opening and closing component has a torsional spring which presses the side pole of said opening and closing component with closing hooks to close.

This utility model offers the following beneficial effects:

This LED light fixture is simple in structure. LED luminaire module is installed on the installation bracket of the aluminium tube which, working both as a heat dissipation device and an installation bracket, directly replaces the overall fluorescent lamp. This removes unnecessary components, decreases unnecessary circuit replacement or alteration, reduces metal materials and makes for longer life span, safer use and more convenient installation.

### BRIEF DESCRIPTION OF THE DRAWINGS

FIG. 1 is a structure decomposition sketch map of this utility model.

FIG. 2 is an input mode of power supply for this utility model.

FIG. 3 is another option of power supply for this utility model.

FIG. 4 is a sketch map of two optional extending connections of this utility model.

FIG. 5 is another optional installation method of this utility model.

FIG. 6 is another optional installation method of this utility model.

### EMBODIMENT

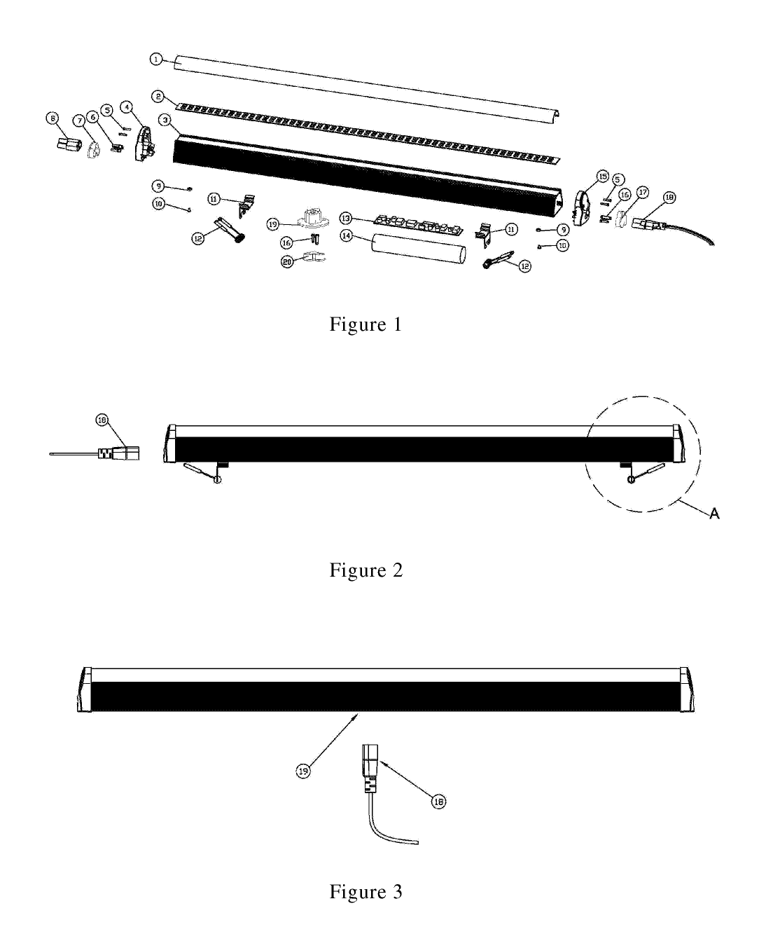

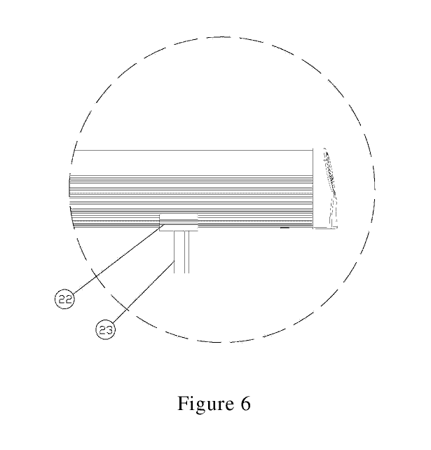

As depicted in FIG. 1 through FIG. 6, this utility model adopts the following technical solution: it includes a lampshade 1, an LED luminaire module 2, an aluminium tube 3, a female end cover 4, a screw 5, a female plug terminal 6, a protective cover 7, a connector 8, a nut 9, a screw 10, an installation buckle 11, a spring 12, a driving circuit module 13, a heat-shrinkable tube 14, a male plug end cover 15, a male plug terminal 16, a protective cover 17, a power supply plug wire 18, a male socket 19 and a protective cover 20. Lampshade 1 covers the surface of aluminum tube 3 and LED luminaire module 2 is installed within the installation groove of aluminium tube 3. Female plug terminal 6 is clasped on female end cover 4, and connected to driving circuit module 13 through two leads. Another ground lead terminal of female plug terminal 6 is fixed with screw 10 via nut 9 on aluminium tube 3. Female end cover 4 is fixed via screw 5 at one end of the aluminium tube 3. Male plug terminal 16 is clasped on male socket end cover 15, and connected to driving circuit module 13 through two leads. The ground lead of male plug terminal 16 is fixed with screw 10 via nut 9 on aluminium tube 3. Male plug end cover 15 is fixed via screw 5 at the other end of the aluminium tube 3. Male socket end cover 15 is set with corresponding power supply plug wire 18 which supplies power through male plug terminal 16 to driving circuit module 13. After converted, driving circuit module 13 supplies power through a lead to LED luminaire module 2 to make it work reliably and stably. There is another optional power supply mode. At the back of aluminium tube 3 is set with male socket 19 into which male plug terminal 16 is plugged. Male plug terminal 16 connects with driving circuit module 13 through leads. Another ground lead terminal of male plug terminal 16 is fixed with screw 10 via nut 9 on aluminium tube 3. When the power source supplies power through male socket 19, male end cover 15 is covered by protective cover 17 to prevent electrical shock. Heat-shrinkable tube 14 is set on driving circuit module 13 for the purpose of protecting driving circuit module 13 and electrically insulating it from the aluminium tube. Said connector 8 may achieve effective extension between LED light fixtures. When the extension is not needed, protective cover 7 covers female end cover 4 to prevent it from touching female plug terminal 6. Installation buckle 11 is buckled on aluminium tube 3. Torsional spring 12 is buckled on installation buckle 11. When installed, torsional spring 12 stretches to make the overall LED light fixture clasped on the ceiling. Installation buckle 11 is a bracket, supporting the bottom of said aluminium tube; the opening and closing component is torsional spring 13, connected with said bracket. Said opening and closing component has a torsional spring which presses the side pole of said opening and closing component with closing hooks to close.

As another optional installation method, aluminium tube 3 is buckled on installation buckle 22 which is further fixed via screw and expandable pole 23 on the wall.

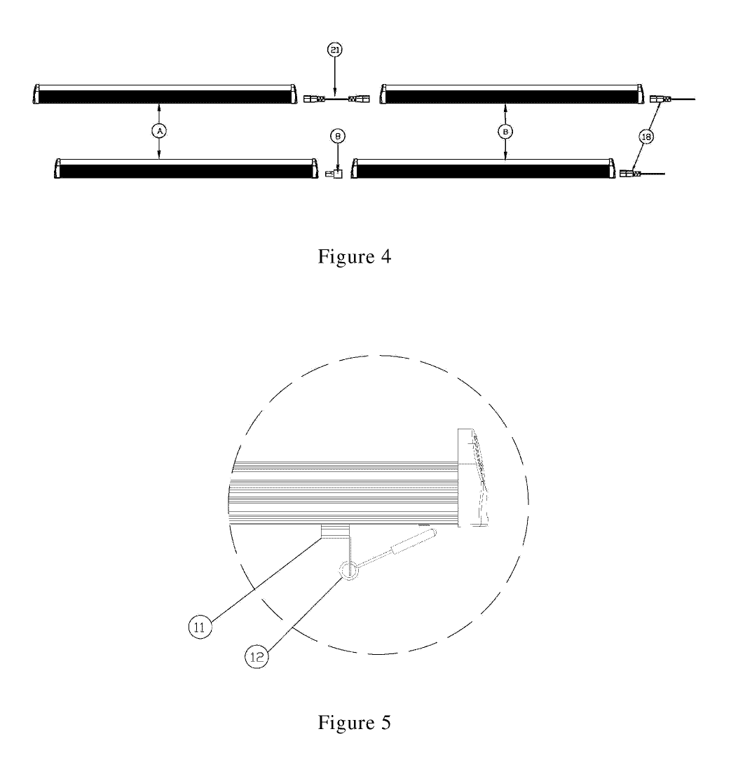

This utility model may also adopt multi-lamp series connection with certain interval and configuration mode, as depicted in FIG. 4. The working power supply leads in lamp B through exclusive power supply plug wire 18, and then leads from lamp B into lamp A through exclusive double coupling device 21. If necessary, a multiple-lamp group may be formed such that less materials for arrangement of wire are used and the lamp installation is more convenient and practical.

This utility model may also adopt multi-lamp seamless transconductance line series connection, as depicted in FIG. 4. The working power supply leads in lamp B through exclusive power supply plug wire 18, and then leads from lamp B in lamp A through exclusive connector 8. If necessary, a multiple-lamp group may be formed such that less materials for arrangement of wire are used and the bright band light given off by the tubes is consistent without a darkened area. The arrangement of lamps is more pleasing and practical.

This utility model may also meet different installation requirements to provide an operation mode of power supply lead-in at the back of the fixture, as depicted in FIG. 3. The working power supply leads in the lamp working power supply through exclusive power supply plug wire 18 and exclusive male socket 19 at the back of the fixture such that the installation of the overall light fixture is more pleasing, and the cabling of lamp suspending and flush mounting is more reasonable so as to make the power transmission line invisible.

This utility model provides a new type of LED light fixture, which includes:

An aluminium tube;

An LED luminaire module, attached to said aluminium tube;

A driving circuit module, electrically connected with said LED luminaire module;

An electric joint, comprising two conductive leads and a ground lead. The two conductive leads are electrically connected with said driving circuit module and the ground lead is connected to said aluminium tube;

Power source, supplying electric energy to said electric joint.

Power source is ordinarily alternating current, it also can be direct current. Electric power is supplied to driving circuit module through electric joint, then supplied to LED luminaire module through driving circuit module.

There are two said electric joints in the said LED light fixture, one being a male electric joint and the other a female electric joint, installed at the two ends of said aluminium tube respectively.

While in use, the male electric joint or the female electric joint can be optionally used according to different types of power output lead. The reason to provide two electric joints is for the convenience of the user. In other words, this utility model can be carried out with only one electric joint, it is an innovation that two electric joints are adopted. The electric joint can be arranged on either end or any part of the aluminium tube. For example, arrange the said electric joints at the rear of said aluminium tube.

Said electric joint includes an end cover and a plug terminal. Said end cover is fixed at one end of the aluminium tube and said plug terminal extends outwardly from within said end cover. The extending end of said plug terminal is electrically connected to the power source while the non-extending end is connected to the driving circuit module.

Said electric joint also includes a protective cover which covers said end cover to protect the extending end of said plug terminal within the space formed between said protective cover and the end cover. The protective cover is for avoiding electric shock or other risks, such as water moist.

Said LED light fixture also includes a connector. One end of said connector is a male end and the other is a female end. Said connector is connected with either of said electric joints. This is to say, the connector is used for structural and electrical connection between multiple LED light fixtures. Structural connection here is to connect multiple LED light fixtures in series, whereas electrical connection enables that power supply on one LED light fixture can be shared by all LED lights connected in series, so that all LED lights together can give out seamless light and the cost of wiring is reduced.

Said LED light fixture also includes installation components which include: A bracket, supporting the bottom of said aluminium tube;

An opening and closing component, connected with said bracket. Said opening and closing component has a torsional spring which presses the side pole of said opening and closing component with closing hooks to close. While in use, the two side poles of the opening and closing component is split apart by hands, the closing hook of the two side poles is opened, and then the closing hook is to be set into the round hole on the ceiling, finally with the loose of hands, the closing hook closes under the effect of the torsional spring, thus connecting the LED light fixture with the ceiling. This mode of connection is easy to disassemble.

In other words, in order to solve the problems existing in the background art, this utility model adopts the following technical solution: it includes a lampshade 1, an LED luminaire module 2, an aluminium tube 3, a female end cover 4, a screw 5, a female plug terminal 6, a protective cover 7, a connector 8, a nut 9, a screw 10, an installation buckle 11, a spring 12, a driving circuit module 13, a heat-shrinkable tube 14, a male plug end cover 15, a male plug terminal 16, a protective cover 17, a power supply plug wire 18, a male socket 19 and a protective cover 20. Lampshade 1 covers the surface of aluminum tube 3 and LED luminaire module 2 is installed within the installation groove of aluminium tube 3. Female plug terminal 6 is connected with three leads and clasped on female end cover 4, female plug terminal 6 is connected to driving circuit module 13 through two leads. Another lead connected to female plug terminal 6 is a ground lead, which is fixed with screw 10 via nut 9 on aluminium tube 3. Aluminium tube 3 is connected with the ground lead. Female end cover 4 is fixed via screw 5 at one end of the aluminium tube 3. Male plug terminal 16 is connected with three leads and clasped on male socket end cover 15, male plug terminal 16 is connected to driving circuit module 13 through two leads. Another lead connected with male plug terminal 16 is a ground lead, which is fixed with screw 10 via nut 9 on aluminium tube 3. Male socket end cover 15 is fixed via screw 5 at the other end of the aluminium tube 3. Male socket end cover 15 is set with corresponding power supply plug wire 18 which supplies power through male plug terminal 16 to driving circuit module 13. Driving circuit module 13 converts and supplies power through a lead to LED luminaire module 2 to make it work reliably and stably. There is another optional power supply mode. At the back of aluminium tube 3 is set with male socket 19 into which male plug terminal 16 is plugged. Male plug terminal 16 connects with driving circuit module 13 through two leads. Another ground lead terminal of male plug terminal 16 is fixed with screw 10 via nut 9 on aluminium tube 3. When the power source supplies power through other parts to the LED light, male end cover 19 is covered by protective cover 20 to prevent electrical shock. When the power source supplies power through male socket 19, male end cover 15 is covered by protective cover 17 to prevent electrical shock. Heat-shrinkable tube 14 is set on driving circuit module 13. Said connector 8 enables effective extension between LED light fixtures. When the extension is not needed, protective cover 7 covers female end cover 4 to prevent it from touching female plug terminal 6. Installation buckle 11 is buckled on aluminium tube 3. Torsional spring 12 is buckled on installation buckle 11. When installed, torsional spring 12 stretches to make the overall LED light fixture clasped on the ceiling. As another optional installation method, aluminium tube 3 is buckled on installation buckle 22 which is further fixed via screw and expandable pole 23 on the wall.

This embodiment possesses the following technical effects:

This LED light fixture is simple in structure. LED luminaire module is installed on the installation bracket of the aluminium tube which, working both as a heat dissipation device and an installation bracket, directly replaces the overall fluorescent lamp. This removes unnecessary components, decreases unnecessary circuit replacement or alteration, reduces metal materials and makes for longer life span, safer use and more convenient installation.

1. A new type of LED light fixture which is characterized in that, it includes:
An aluminium tube;
An LED luminaire module, attached to said aluminium tube;
A driving circuit module, electrically connected with said LED luminaire module;
An electric joint, comprising two conductive leads and a ground lead. The two conductive leads are electrically connected with said driving circuit module and the ground lead is connected to said aluminium tube;
Power source, supplying electric energy to said electric joint.

2. The LED light fixture described in claim 1 is characterized in that, there are two said electric joints, one being a male electric joint and the other a female electric joint, installed at the two ends of said aluminium tube respectively.

3. The LED light fixture described in claim 1 is characterized in that, said electric joints are installed at the rear of said aluminium tube.

4. The LED light fixture described in claim 1 is characterized in that, said electric joint includes an end cover and a plug terminal, said end cover is fixed at one end of the aluminium tube and said plug terminal extends outwardly from within said end cover. The extending end of said plug terminal is electrically connected to the power source while the non-extending end is connected to the driving circuit module.

5. The LED light fixture described in claim 4 is characterized in that, said electric joint also includes a protective cover which covers said end cover to protect the extending end of said plug terminal within the space formed between said protective cover and the end cover.

6. The LED light fixture described in claim 2 is characterized in that, said LED light fixture also includes a connector. One end of said connector is a male connector and the other end is a female connector. Said connector is connected with either of said electric joints.

7. The LED light fixture described in claim 2 is characterized in that, said LED light fixture also includes installation components, which includes: a bracket, supporting the bottom of said aluminium tube; an opening and closing component, connected with said bracket. Said opening and closing component has a torsional spring which presses the side pole of said opening and closing component with closing hooks to close.
